(19) United States
(12) Patent Application Publication
(10) Pub. No.: US 2017/0180752 A1
(43) Pub. Date: Jun. 22, 2017

(54) METHOD AND ELECTRONIC APPARATUS FOR IDENTIFYING AND CODING ANIMATED VIDEO

(71) Applicants: Le Holdings (Beijing) Co., Ltd., Beijing (CN); LeCloud Computing Co., Ltd., Beijing (CN)

(72) Inventors: Yang Liu, Beijing (CN); Yangang Cai, Beijing (CN); Wei Wei, Beijing (CN); Maosheng Bai, Beijing (CN)

(21) Appl. No.: 15/246,955

(22) Filed: Aug. 25, 2016

Related U.S. Application Data
(63) Continuation of application No. PCT/CN2016/088689, filed on Jul. 5, 2016.

(30) Foreign Application Priority Data
Dec. 18, 2015 (CN) 201510958701.0

(51) Int. Cl. H04N 19/56; H04N 19/186; H04N 19/172; H04N 19/136

(52) U.S. Cl. CPC H04N 19/56; H04N 19/136; H04N 19/186; H04N 19/172

(57) ABSTRACT

Disclosed are a method and an electronic apparatus for identifying and coding animated video. By dimensionally reducing a video to be identified, obtain an input characteristic parameter of the video to be identified; by invoking a characteristic model trained in advanced according to the input characteristic parameter, determine whether the video to be identified is an animated video; and when it is determined the video to be identified is the animated video, adjust a coding parameter and a bit rate of the video to be identified. The bandwidth is saved and the coding efficiency is raised in the situation that high resolution video is obtained.

### CROSS REFERENCE TO RELATED APPLICATIONS

This application is a continuation of International Application No. PCT/CN2016/088689, filed on Jul. 5, 2016, which is based upon and claims priority to Chinese Patent Application No. 201510958701.0, titled as “method and device for identifying and coding animated video” and filed on Dec. 18, 2015, the entire contents of which are incorporated herein by reference.

### TECHNICAL FIELD

The present disclosure relates to the field of video technologies, more particular to a method and an electronic apparatus for identifying and coding animated videos.

### BACKGROUD

When the technology of multimedia develops rapidly, a plenty of animated videos are produced and spread via the interconnection internet.

For video websites, it is necessary to recode videos so that users could watch the videos smoothly and clearly. Comparing to the content of traditional videos (TV dramas, movie, etc), the content of animated videos is simple and has features of concentrative color distributions and sparse contour lines. Based on the above features, the coding parameters of the animated videos could be different from the coding parameters of the videos of traditional contents in the situation of obtaining the same resolution. For example, the coding bit rate of the animated videos could be decreased and the animated videos having the decreased coding bit rate could obtain the same resolution as the videos of traditional contents having a high bit rate.

Therefore, it is urgent to propose a method and an electronic apparatus for identifying and coding animated videos.

### SUMMARY

In the present application, a method and a device for identifying and coding animated videos are provided to resolve the deficiency of manually switching the output modes of videos in prior art, so that the automatic switching of the output modes of videos could be achieved.

In one embodiment of the present application, a method for identifying and coding animated video is provided. The method includes the following steps:

Dimensionally reducing a video to be identified, obtaining an input characteristic parameter of the video to be identified;

Invoking a characteristic model trained in advanced according to the input characteristic parameter, determining whether the video to be identified is an animated video;

When it is determined the video to be identified is the animated video, adjusting a coding parameter and a bit rate of the video to be identified.

In the embodiments of the present application, a non-volatile computer storage medium is provided. The non-volatile computer storage medium stores computer-executable instructions configured to implement any of methods for identifying and coding animated video in the present application.

In the embodiments of the present application, an electronic apparatus is provided. The electronic apparatus includes: at least one processor and a memory; wherein, the memory stores programs which could be executed by the at least one processor. The instructions are executed by the at least one processor so that the at least one processor is capable of implementing any of the above methods for identifying and coding animated video in the present application.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed. In the figures:

FIG. 1 is a technical flow chart of an embodiment of the present disclosure;

FIG. 2 is a technical flow chart of another embodiment of the present disclosure;

FIG. 3 is a schematic diagram of the device of another embodiment;

FIG. 4 is a schematic diagram of the device connection of another embodiment.

### DETAILED DESCRIPTION

In order to clarify the purpose, technical solutions, and merits of the present disclosure, the technical solutions in the embodiments of the present disclosure are illustrated clearly and fully with figures of the embodiments of the present disclosure. Obviously, the illustrated embodiments are not all embodiments but part of embodiments of the present disclosure. Based on the embodiments of the present disclosure, other embodiments obtained by persons having ordinary skills in the art without creative efforts provided are within the scope of the present disclosure.

### Embodiment 1

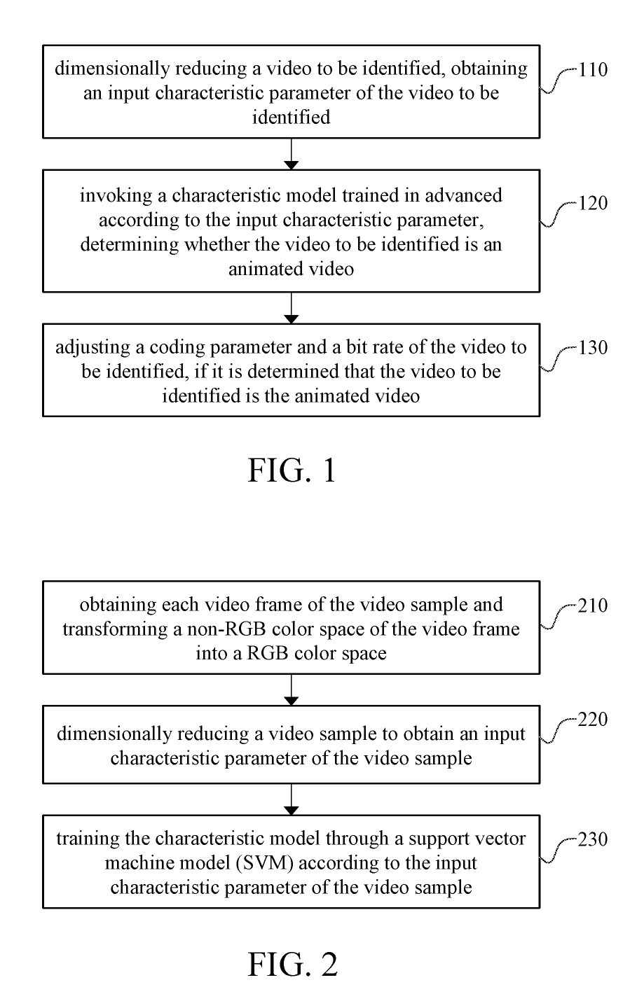

FIG. 1 is a technical flow chart of the embodiment 1 of the present disclosure. Please refer to FIG. 1, a method for identifying and coding animated video in accordance with one embodiment of the present disclosure. The method mainly includes the following three steps:

Step 110: dimensionally reducing a video to be identified, obtain an input characteristic parameter of the video to be identified;

In the embodiment of the present disclosure, the purpose of dimensionally reducing the video to be identified is to obtain the input characteristic parameter of a video frame. The high dimensionality of the video frame is transformed into a low dimensionality expressed as the input characteristic parameter for matching the characteristic model trained in advanced so that the video to be identified is classified. The specific process of dimensional reduction is specifically implemented via the following step 111 to step 113:

Step 111: obtain each video frame of the video to be identified, and transform a non-RGB color space of video frame into a RGB color space.

The formats of a plenty of videos to be processed are different and their corresponding color spaces are various. It is necessary to transform those color spaces into the same color space. The videos to be processed are classified according to the same standard and parameter so that the complexity of classification calculation is simplified and the accuracy of classification is raised. In the following description, the transformation formula for transforming non-RGB color space into RGB color space will illustrated as an example. Certainly it should be realized that the following description is just for further illustrating in the embodiments of the present disclosure but will not constitute limitations on the embodiments of the present disclosure. Any algorithm for transforming non-RGB color spaces into RBG color spaces which could implement the embodiments of the present disclosure is within the scope of the present disclosure.

As the formula shown below, any colored light in the nature can be formed by mixing RGB three primary colors according to various proportions:

F=r*R+g*G+b*B

The coordinate of F will be changed by adjusting any of r, g, b three coefficients. It means the color value of F is changed. When the component of each primary color is 0 (weakest), the mixed light of them is black. When the component of each primary color is k (strongest), the mixed light of them is white.

A RGB color space is represented via physical three primary colors, so the physical meaning is clear. However, the organization of the RGB color space is not suited to visual features of human. Therefore, other representations of color spaces are generated such as CMY color spaces, CMYK color spaces, HIS color spaces, HSV color spaces, etc.

The papers of colorful printing could not reflect lights, so printers or colorful printers can only use some inks or pigments capable of absorbing specific light waves and reflecting other light waves. The three primary colors of inks or the three primary colors of pigments are cyan, magenta, and yellow, abbreviated to CMY. A CMY space is complementary to RGB space. That means white minus one color value of a RGB space leaves a value equivalent to the value of the same color in a CMY space. When a CMY color space is transformed into RGB color space, the transforming formula below could be applied:

$$\{ \begin{matrix}R = 1 - C \\ G = 1 - M \\ B = 1 - Y\end{matrix}$$

wherein the value range of C, M, Y is [1,1].

When a CMYK (C: cyan, M: magenta, Y: yellow, and black: K) color space is transformed into RGB color space, the transforming formula below could be applied:

R=1−min {1,C×(1−B)+B}

G=1−min {1,M×(1−B)+B}

B=1−min {1, Y×(1−B)+B}

HSI (Hue, Saturation and Intensity) color space describes colors using hue, color saturation(Chroma) and intensity (brightness) according to the human visual system. The HSI color space could describe colors using a conical space model. When the HSI color space is transformed into RGB color space, the transforming formula below could be applied:

$$\begin{matrix}when 0 < H < 120 \\ B = I ( 1 - S ) \\ R = I \{ 1 + \frac{S \times cos H}{cos ( 60 - H )} \} \\ G = 3 I - ( R + B ) & ( 1 ) \\ when 0 < H < 240 , H = H - 120 \\ R = I ( 1 - S ) \\ R = I \{ 1 + \frac{S \times cos H}{cos ( 60 - H )} \} \\ B = 3 I - ( R + G ) & ( 2 ) \\ when 240 < H < 360 , H = H - 240 \\ G = I ( 1 - S ) \\ B = I \{ 1 + \frac{S \times cos H}{cos ( 60 - H )} \} \\ R = 3 I - ( B + G ) & ( 3 )\end{matrix}$$

Step 112: after transforming a non-RGB color space of each of the video frame into a RGB color space, count a R grayscale histogram, a G grayscale histogram, a B grayscale histogram of the RGB color space, and respectively calculate a standard deviation of the R grayscale histogram, a standard deviation of the G grayscale histogram, and a standard deviation of the B grayscale histogram.

In this step, label R, G, B grayscale histogram as hist_R[256], hist_G[256] and hist_B[256]. Calculate a standard deviation of hist_R[256], a standard deviation of hist_G[256] and a standard deviation of hist_B12561, respectively labeled as sd_R, sd_G, sd_B.

Step 113: respectively implementing an edge detection processing for each of the video frame at a R color channel, a G color channel, and a B color channel, obtain a number of a plurality of contours of the R color channel, a number of a plurality of contours of the G color channel and a number of a plurality of contours of the B color channel

An edge detection processing is implemented for an image of each of R channel, G channel and B channel, and then the number of contours of each of R channel, G channel and B channel is counted and labeled as c_R, c_B.

Thereby, the input characteristic parameter of the video to be processed is obtained, which are a standard deviation sd_R of R color channel, a standard deviation sd_G of G color channel, and a standard deviation sd_B of B color channel, as well as the number of contours c_R of R color channel, the number of contours c_G of G color channel and the number of contours c_B of B color channel.

Step 120: Invoke a characteristic model trained in advanced according to the input characteristic parameter, determine whether the video to be identified is an animated video;

In the embodiment of the present disclosure, the characteristic model trained in advanced is expressed as:

$$f ( x ) = sgn \{ {\sum }_{i = 1}^{l} {α}_{i}^{*} {y}_{i} K ( x , {x}_{i} ) + {b}^{*} \}$$

wherein x represents an input characteristic parameter of the video to be identified. xᵢ represents an input characteristic parameter of the video sample. f(x) represents a classification of the video to be identified. sgn( )represents a characteristic of a symbol function. K is a kernel function. a*ᵢ and b* respectively represent a relative parameter of the characteristic model.

The symbol function only have two the return values which are 1 or −1. The symbol function could be more specifically represented as following via a step signal u(x):

$$sgn ( x ) = 2 u ( x ) - 1 = \{ \begin{matrix}1 , & x > 0 \\ 0 , & x = 0 \\ - 1 , & x < 0\end{matrix}$$

Therefore, by inputting the input characteristic parameter obtained in step 110 into the characteristic model, 1 or −1 would be obtained by calculation. 1 and −1 are respectively two possibilities of the video to be processed: animated video and non-animated video. The training process of the characteristic model will be illustrated in detail in the following embodiment 2.

Step 130, when it is determined the video to be identified is an animated video, adjust the coding parameter and the bit rate of the video to be identified.

Because the content of animated videos is simple and has features of concentrative color distributions and sparse contour lines, corresponding coding parameters (e.g., bit rate, quantization parameter, etc) could be adjusted so that the coding bit rate is decreased and the coding speed is increased.

In the embodiment, the video to be processed is reduced dimensionally and the characteristic model trained in advanced is adjusted to identify whether the video to be processed is the animated video. Thereby the coding parameter is adjusted according to the identifying result. As a result, the high coding efficiency and the save of coding bandwidth could be achieved in the situation that video resolution remains the same.

### Embodiment 2

Please refer to FIG. 2. FIG. 2 is a technical flow chart of the embodiment 2 of the present disclosure. The following descriptions will be combined with FIG. 2 to specifically illustrate a training process of characteristic model in a method for identifying and coding animated video in one embodiment of the present disclosure.

In one embodiment of the present disclosure, the characteristic model is trained using a certain number of animated video samples and non-animated video samples. The more samples used for training the characteristic model, the more accurate the classification of the trained model is. First of all, positive sample (animated video) and negative sample (non-animated video) would be obtained by classifying the video samples. The lengths of the video samples are random, and the contents of the video samples are random.

Step 210: obtain each video frame of the video sample and transform a non-RGB color space of each of the video frame into a RGB color space;

By analyzing the positive samples and the negative samples, it is discovered that the significant difference between the positive samples and the negative samples is that color distributions are concentrative and contour lines are sparse in the frames of the positive samples. Therefore, in the present disclosure, the above characteristic is used as the training input characteristic. For each frame of the samples, when YUV420 format is used, the number of dimensionality of the input space is expressed as n=width*height* 2, wherein width and height respectively represent width of the video frame and height of the video frame. Because it is difficult to process the amount of data, it is necessary to dimensionally reduce the videos samples first in the embodiments of the present disclosure. Specifically, a certain number of essential characteristics are extracted from each video frame having a dimensionality of n, and the essential characteristics are used as dimensionalities to achieve the purpose of dimensional reduction. Thereby the training process of the model is simplified and the calculation is reduced. Further the characteristic model is optimized.

The implementation of the principles and the technical effects in the embodiment are the same as in step 110, and not repeated.

Step 220: dimensionally reduce a video sample to obtain an input characteristic parameter of the video sample;

As described in the embodiment 1, the input characteristic parameters of the video to be processed are a standard deviation sd_R of R color channel, a standard deviation sd_G of G color channel, and a standard deviation sd_B of B color channel, as well as the number of contours c_R of R color channel, the number of contours c_G of G color channel and the number of contours c_B of B color channel. The dimensionality of the dimensionally reduced video frame will decreases from n to 6.

Step 230: train the characteristic model through a support vector machine (SVM) model according to the input characteristic parameter of the video sample.

Specifically, in the embodiment of the present disclosure, the type of support vector machine is a nonlinear soft margin classifier (C-SVC) as shown in formula (1) expressed as:

$${min}_{w , b} \frac{1}{2} {‖ w ‖}^{2} + c {\sum }_{i = 1}^{1} {ɛ}_{i}$$

subject to:

yᵢ((w×xᵢ, +b))≧−εᵢ, i=1, . . . , 1

εᵢ≧0,i=1, . . . , 1

C>0 (1)

In the formula (1), C represents a penalty parameter. εᵢ represents a slack variable of the i^{th} sample video. xᵢ represents the input characteristic parameter of the i^{th} sample video. The input characteristic parameters are the standard deviation sd_R of R color channel, the standard deviation sd_G of G color channel, and the standard deviation sd_B of B color channel, as well as the number of contours c_R of R color channel, the number of contours c_G of G color channel and the number of contours c_B of B color channel. yᵢ represents the type of the i^{th} sample video (which is the video is animated video or non-animated video, for example, 1 could be set as animated video and −1 could be set as animated video, etc). l represents the total number of the video samples. The symbol “∥ ∥” represent norm. w and b are relevant parameters. “subject to” represents “restricted by” and could be used in the form shown in the formula (1). That means the objective function subject to restrictions.

A formula (2) for calculating the parameter w is expressed as:

$$w = {\sum }_{i = 1}^{l} {y}_{i} {α}_{i} {x}_{i} \qquad ( 2 )$$

In the formula (2), xᵢ represents the input characteristic of the i^{th} sample video. yᵢ represents the type of the i^{th} sample video.

The dual problem of the formula (1) is shown in formula (3) expressed as,

$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j} \\ s . t . \text{:} \\ {\sum }_{i = 1}^{l} {y}_{i} {α}_{i} = 0 \\ 0 \leq {α}_{i} \leq C , i = 1 , … , l \qquad ( 3 )$$

In the formula (3), s.t.=subject to, representing that the objective function before s.t is subject to the restriction after s.t. xᵢ represents the input characteristic parameter of the i^{th} sample video. yᵢ represents the type of the i^{th} sample video. xⱼ represents the input characteristic parameter of the j^{th} sample video. y₁ represents the type of the j^{th} sample video. a is a best solution obtained via the formula (1) and the formula (2). C represent a penalty parameter. In the embodiment, the initial value of the penalty parameter C is set as 0.1. 1 l represents the total number of the sample videos. K(xᵢ, xⱼ) represents a kernel function. In the embodiment, radial basis function (RBF) is selected as the kernel function shown in the formula (4) expressed as:

$$K ( {x}_{i} , {x}_{j} ) = exp \{ \frac{{‖ {x}_{i} - {x}_{j} ‖}^{2}}{2 {σ}^{2}} \} \qquad ( 4 )$$

In the formula (4), xᵢ represents a sample characteristic parameter of the i^{th} sample video. xⱼ represents a sample characteristic parameter of the j^{th} sample video. σ is an adjustable parameter of the kernel function. In the embodiment, the initial value of the parameter σ of RBF is set as le-5.

According to the formula (1) to the formula (4), the best solution of the formula (3) could be calculated as shown in formula (5) expressed as:

a*=(a*₁, . . . a*ₗ)^{T} (5)

According to a*, b* could be obtained as shown in the formula (6) expressed as:

$${b}^{*} = {y}_{j} - {\sum }_{i = 1}^{l} {y}_{i} {α}_{i}^{*} K ( {x}_{i} , {x}_{j} ) \qquad ( 6 )$$

In the formula (6), a value of j is obtained by selecting a positive component

0<a*ⱼ<C from a*ⱼ.

Secondly, according to the relevant parameter a* and the relevant parameter b*, the characteristic model for identifying video could be obtained shown in the formula (7):

$$f ( x ) = sgn ( {\sum }_{i = 1}^{l} {α}_{i}^{*} {y}_{i} K ( x , {x}_{i} ) + {b}^{*} ) \qquad ( 7 )$$

Furthermore, it should be noted that the cross validation algorithm is selected for the characteristic model to search a best value of the parameter σ and a best value of C to raise the generalization of the training model in the embodiment of the present disclosure. Specifically, k-folder cross-validation is selected.

In the k-folder cross-validation, a sample is initially divided into a number of K subsamples. One of the number of K subsamples is reserved as data of a verification model, and the rest of the number of K−1 subsamples are used for training. The cross-validation will be implemented repeatedly for K times. The cross-validation is implemented once for each subsample, and according to the result of average of cross-validation repeated for K times or other combination, eventually a single estimation would be obtained. The advantage of the method is that the subsamples randomly generated are used for training and verification concurrently and repeatedly and each result is verified once.

In the embodiment of the present disclosure, the selectable number of fold k is 5. The penalty parameter C is set within the range of [0.01 , 200]. The parameter σ of the kernel function is set within the range of [le-6, 4]. The step length of σ and the step length of C both are 2 during the verification process.

In the embodiment, by analyzing animated video samples and non-animated video samples, the difference between the animated video and non-animated video is obtained. At the same time, by dimensionally reducing the video, the characteristic parameters of two types of video samples are extracted. Moreover, the model is trained using the characteristic parameters so that a characteristic model capable of identifying the video to be classified is obtained. Thereby coding parameter could be adjusted according to the type of the video so that the advantages of save of bandwidth and increasing coding speed could be achieved in the situation that the video having a high resolution is obtained.

### Embodiment 3

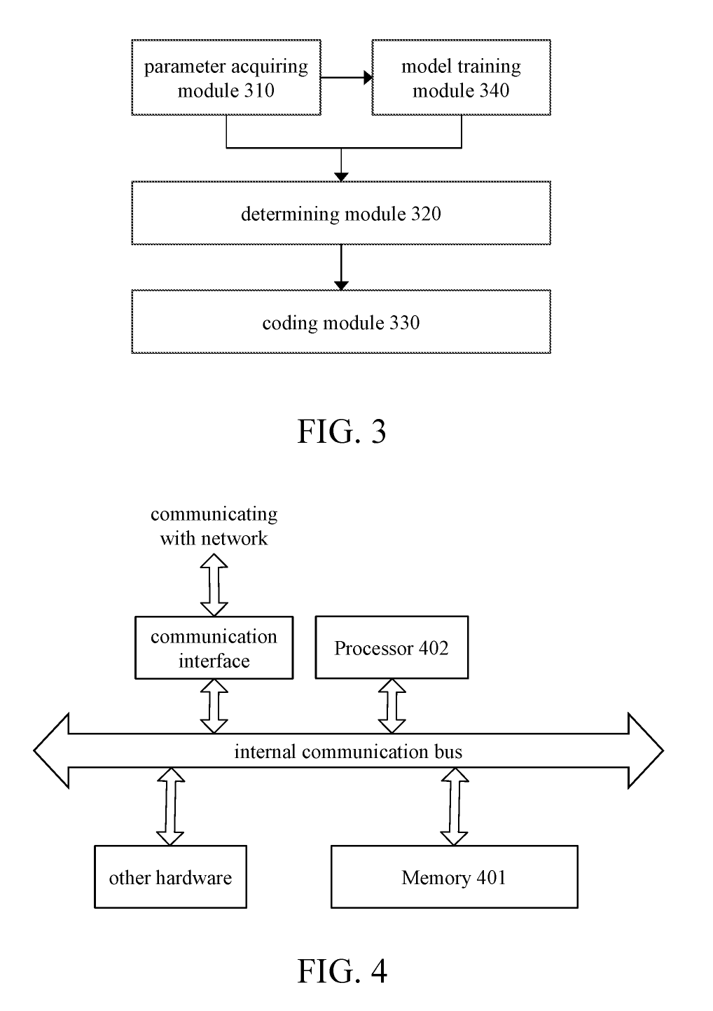

Please refer to FIG. 3. FIG. 3 is a schematic diagram of the device of the embodiment 3. Combining with FIG. 3, a device for identifying and coding animated video in one embodiment of the present disclosure mainly includes the following modules: a parameter acquiring module 310, a determining module 320, a coding module 330 and a model training module 340.

The parameter acquiring module 310 is configured to dimensionally reduce a video to be identified and acquire an input characteristic parameter of the video to be identified;

The determining module 320 is configured to invoke a characteristic model trained in advanced according to the input characteristic parameter and determine whether the video to be identified is an animated video;

The coding module 330 is configured to adjust a coding parameter of the video to be identified and a bit rate of the video to be identified when it is determined the video to be identified is the animated video.

The parameter acquiring module 310 is further configured to obtain each video frame of the video to be identified, transform a non-RGB color space of each of the video frames into a RGB color space, count a R grayscale histogram, a G grayscale histogram, a B grayscale histogram of the RGB color space, respectively calculate a standard deviation of the R grayscale histogram, a standard deviation of the G grayscale histogram, and a standard deviation of the B grayscale histogram, respectively implement an edge detection processing for each of the video frame at a R color channel, a G color channel, and a B color channel, obtain a number of a plurality of contours of the R color channel, a number of a plurality of contours of the G color channel and a number of a plurality of contours of the B color channel

The model training module 340 is configured to adjust the parameter acquiring module to dimensionally reduce a video sample to obtain the input characteristic parameter of the video sample, wherein the input characteristic parameter includes the standard deviation of the R grayscale histogram, the standard deviation of the G grayscale histogram and the standard deviation of the B grayscale histogram, as well as the number of the plurality of contours of the R color channel, the number of the plurality of contours of the G color channel and the number of the plurality of contours of the B color channel, and train the characteristic model through a support vector machine model according to the input characteristic parameter of the video sample.

Specifically, the model training module 340 trains the characteristic model expressed as:

$$f ( x ) = sgn \{ {\sum }_{i = 1}^{l} {α}_{i}^{*} {y}_{i} K ( x , {x}_{i} ) + {b}^{*} \}$$

wherein x represents an input characteristic parameter of the video to be identified. xᵢ represents an input characteristic parameter of the video sample. f(x) represents a classification of the video to be identified. An output value of f(x) is 1 or −1 according to a characteristic of a symbol function sgn( ) 1 or −1 respectively represents an animated video and a non-animated video, K is a kernel function calculated according to a predetermined adjustable parameter and the input characteristic parameter of the video sample, a*ᵢ and b* respectively represents a relative parameter of the characteristic model, and b^{*} are calculated according to a predetermined penalty parameter and the input characteristic parameter of the video sample.

The model training module 340 is further configured to: train the characteristic model through the support vector machine model and select a cross-validation algorithm to search the adjustable parameter and the penalty parameter so that a generalization of the characteristic model is raised.

FIG. 3 corresponds to the device implementing the embodiments in FIG. 1 and FIG. 2 and the implementation principles and technical effects could be obtained by referring to the embodiments in FIG. 1 to FIG. 3.

### Embodiment 4

FIG. 4 is a schematic diagram of an electronic apparatus for implementing the method for identifying and coding animated video. The electronic apparatus includes:

One or more processors 402 and a memory 401, and a processor 402 is an example in FIG. 4.

The processor 402, the memory 401 can be connected to each other via a bus or other members for connection. In FIG. 4, they are connected to each other via the bus in this embodiment.

The memory 401 is one kind of non-volatile computer-readable storage mediums applicable to store non-volatile software programs, non-volatile computer-executable programs and modules; for example, the program instructions and the function modules corresponding to the method for identifying and coding animated video in the embodiments are respectively a computer-executable program and a computer-executable module. The processor 402 executes function applications and data processing of the server by running the non-volatile software programs, non-volatile computer-executable programs and modules stored in the memory 30, and thereby the methods for identifying and coding animated video in the aforementioned embodiments are achievable.

The memory 401 can include a program storage area and a data storage area, wherein the program storage area can store an operating system and at least one application program required for a function; the data storage area can store the data created according to the usage of the device for video switch. Furthermore, the memory 401 can include a high speed random-access memory, and further include a non-volatile memory such as at least one disk storage member, at least one flash memory member and other non-volatile solid state storage member. In some embodiments, the memory 401 can have a remote connection with the processor 402, and such memory can be connected to the device for video switch by a network. The aforementioned network includes, but not limited to, internet, intranet, local area network, mobile communication network and combination thereof.

The one or more modules are stored in the memory 401. When the one or more modules are executed by one or more processor 402, the method for identifying and coding animated video disclosed in any one of the embodiments is performed.

The aforementioned product can execute the method provided by the embodiments of the present application and have a block module and benefits corresponding to the executing method. Technical details not described clearly in the embodiment can be found in the method for identifying and coding animated video provided by the embodiments of the present application.

Combining with FIG. 4, the device for identifying and coding animated video provided in one embodiment of the present disclosure includes a memory 401 and a processor 402, wherein,

The memory 401 is configured to store one or more instructions provided to the processor 402 for execution.

The processor 402 is configured to dimensionally reduce a video to be identified and acquire an input characteristic parameter of the video to be identified;

invoke a characteristic model trained in advanced according to the input characteristic parameter and determine whether the video to be identified is an animated video;

adjust a coding parameter of the video to be identified and a bit rate of the video to be identified when it is determined the video to be identified is the animated video.

The processor 402 is further configured to: obtain each video frame of the video to be identified, transform a non-RGB color space of each of the video frames into a RGB color space; count a R grayscale histogram, a G grayscale histogram, a B grayscale histogram of the RGB color space; respectively calculate a standard deviation of the R grayscale histogram, a standard deviation of the G grayscale histogram and a standard deviation of the B grayscale histogram; respectively implementing an edge detection processing for each of the video frame at a R color channel, a G color channel, and a B color channel; obtain a number of a plurality of contours of the R color channel, a number of a plurality of contours of the G color channel and a number of a plurality of contours of the B color channel.

The processor 402 is further configured to adjust the parameter acquiring module to dimensionally reduce a video sample to obtain the input characteristic parameter of the video sample, wherein the input characteristic parameter includes the standard deviation of the R grayscale histogram, the standard deviation of the G grayscale histogram and the standard deviation of the B grayscale histogram, as well as the number of the plurality of contours of the R color channel, the number of the plurality of contours of the G color channel and the number of the plurality of contours of the B color channel, and train the characteristic model through a support vector machine model according to the input characteristic parameter of the video sample.

Specifically, the processor 402 is further configured to train the following characteristic model expressed as:

$$f ( x ) = sgn \{ {\sum }_{i = 1}^{l} {α}_{i}^{*} {y}_{i} K ( x , {x}_{i} ) + {b}^{*} \}$$

wherein x represents an input characteristic parameter of the video to be identified. xᵢ represents an input characteristic parameter of the video sample. f(x) represents a classification of the video to be identified. An output value of f(x) is 1 or −1 according to a characteristic of a symbol function sgn( ) 1 or −1 respectively represents an animated video and a non-animated video. K is a kernel function calculated according to a predetermined adjustable parameter and the input characteristic parameter of the video sample, a*ᵢ and b* respectively represents a relative parameter of the characteristic model. a*ᵢ and b* are calculated according to a predetermined penalty parameter and the input characteristic parameter of the video sample.

The processor 402 is further configured to: train the characteristic model through the support vector machine model and select a cross-validation algorithm to search the adjustable parameter and the penalty parameter so that a generalization of the predetermined characteristic model is raised.

The electronic apparatus in the embodiments of the present application may be presence in many forms including, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The technical solutions and functional features and connections of each module of the device correspond to the features and technical solutions described in the embodiments of FIG. 1 to FIG. 3. Please refer to the aforementioned embodiments of FIG. 1 to FIG. 3 if it is inadequate.

### Embodiment 5

In the embodiment 5 of the present application, a non-volatile computer storage medium is provided. The computer storage medium stores computer-executable instructions, and the computer-executable instructions can carry out the method for identifying and coding animated video in any one of the embodiments.

The embodiments of device described above are exemplary, wherein the units described as separate components could be or could not be physically separated. The components used for unit display could be or could not be physical units. The components could be located in one place or could be spread over multiple network elements. According to the actual demand, part of modules or all modules can be selected to achieve the purpose of the embodiments of the present disclosure. Persons having ordinary skills in the art could realize and implement the embodiments of the present disclosure without providing creative efforts.

Through the above descriptions of embodiments, those skilled in the art can clearly realize each embodiment can be implemented using software plus essential common hardware platforms. Certainly each embodiment can be implemented using hardware. Based on the understanding, the above technical solutions or part of the technical solutions contributing to the prior art could be embodied in form of software products. The computing software products can be stored in a computer-readable storage medium such as ROM/RAM, disk, compact disc, etc. The computing software products include several instructions configured to make a computing device (a personal computer, a server, or internet device, etc) carry out the methods in each embodiments or part of methods in the embodiments.

Finally, it should be noted that: the above embodiments are just used for illustrating the technical solutions of the present disclosure and not for limiting the present disclosure. Even though the present disclosure is illustrated clearly referring to the previous embodiments, persons having ordinary skills in the art should realize the technical solutions described in the aforementioned embodiments can be modified or part of technical features can be displaced equivalently. The modification or the displacement would not make corresponding essentials of the technical solutions out of spirit and scope of the technical solution of each embodiment of the present disclosure.

What is claimed is:

1. A method for identifying and coding animated video applied to a terminal, comprising;
dimensionally reducing a video to be identified, obtaining an input characteristic parameter of the video to be identified;
invoking a characteristic model trained in advanced according to the input characteristic parameter, determining whether the video to be identified is an animated video; and
adjusting a coding parameter and a bit rate of the video to be identified , if it is determined that the video to be identified is the animated video.

2. The method according to claim 1, wherein the dimensionally reducing the video to be identified comprises:
obtaining each video frame of the video to be identified;
transforming a non-RGB color space of the video frame into a RGB color space;
counting a R grayscale histogram, a G grayscale histogram, a B grayscale histogram of the RGB color space;
respectively calculating a standard deviation of the R grayscale histogram, a standard deviation of the G grayscale histogram, and a standard deviation of the B grayscale histogram; and
respectively implementing an edge detection processing for the video frame at a R color channel, a G color channel, and a B color channel, obtaining a number of contours of the R color channel, a number of contours of the G color channel and a number of contours of the B color channel

3. The method according to claim 1, wherein the characteristic model trained in advanced comprises:
dimensionally reducing a video sample to obtain an input characteristic parameter of the video sample, wherein the input characteristic parameter of the video sample includes the standard deviation of R grayscale histogram, the standard deviation of G grayscale histogram, the standard deviation of B grayscale histogram, the number of contours of R color channel, the number of contours of G color channel and the number of contours of B color channel; and
training the characteristic model through a support vector machine model according to the input characteristic parameter of the video sample.

4. The method according to claim 3, wherein the training the characteristic model through the support vector machine further comprises:
the characteristic model is expressed as a formula following:
$$f ( x ) = sgn \{ {\sum }_{i = 1}^{l} {α}_{i}^{*} {y}_{i} K ( x , {x}_{i} ) + {b}^{*} \} ;$$
wherein x represents an input characteristic parameter of the video to be identified, xᵢ represents an input characteristic parameter of the video sample, f(x) represents a classification of the video to be identified, an output value of f(x) is 1 or −1 according to a characteristic of a symbol function sgn( )1 or −1 respectively represents an animated video and a non-animated video; K is a kernel function calculated according to a predetermined adjustable parameter and the input characteristic parameter of the video sample; a*ᵢ and b* respectively represents a relative parameter of the characteristic model, a*ᵢ and b* are calculated according to a predetermined penalty parameter and the input characteristic parameter of the video sample.

5. The method according to claim 4, comprising:
selecting a cross-validation algorithm to search the adjustable parameter and the penalty parameter, if the characteristic model is trained through the support vector machine model .

6. A non-volatile computer storage medium storing computer-executable instructions, the computer-executable instructions set as:
dimensionally reducing a video to be identified, obtaining an input characteristic parameter of the video to be identified;
invoking a characteristic model trained in advanced according to the input characteristic parameter, determining whether the video to be identified is an animated video; and
adjusting a coding parameter and a bit rate of the video to be identified, if it is determined that the video to be identified is the animated video.

7. The non-volatile computer storage medium according to claim 6, the dimensionally reducing the video to be identified comprises:
obtaining each video frame of the video to be identified;
transforming a non-RGB color space of the video frame into a RGB color space;
counting a R grayscale histogram, a G grayscale histogram, a B grayscale histogram of the RGB color space;
respectively calculating a standard deviation of the R grayscale histogram, a standard deviation of the G grayscale histogram, and a standard deviation of the B grayscale histogram; and
respectively implementing an edge detection processing for the video frame at a R color channel, a G color channel, and a B color channel, obtaining a number of contours of the R color channel, a number of contours of the G color channel and a number of contours of the B color channel

8. The non-volatile computer storage medium according to claim 6, wherein, the characteristic model trained in advanced comprises:
dimensionally reducing a video sample to obtain an input characteristic parameter of the video sample, wherein the input characteristic parameter of the video sample includes the standard deviation of R grayscale histogram, the standard deviation of G grayscale histogram, the standard deviation of B grayscale histogram, the number of contours of R color channel, the number of contours of G color channel and the number of contours of B color channel; and
training the characteristic model through a support vector machine model according to the input characteristic parameter of the video sample.

9. The non-volatile computer storage medium according to claim 8, wherein, training the characteristic model through the support vector machine further comprises:
the characteristic model is expressed as a formula following:
$$f ( x ) = sgn \{ {\sum }_{i = 1}^{l} {α}_{i}^{*} {y}_{i} K ( x , {x}_{i} ) + {b}^{*} \} ;$$
wherein x represents an input characteristic parameter of the video to be identified, xᵢ represents an input characteristic parameter of the video sample, f(x) represents a classification of the video to be identified, an output value of f(x) is 1 or −1 according to a characteristic of a symbol function sgn( )1 or −1 respectively represents an animated video and a non-animated video; K is a kernel function calculated according to a predetermined adjustable parameter and the input characteristic parameter of the video sample; a*ᵢ and b* respectively represents a relative parameter of the characteristic model, a*ᵢ and b* are calculated according to a predetermined penalty parameter and the input characteristic parameter of the video sample.

10. The non-volatile computer storage medium according to claim 9, wherein, the instructions are further set as: selecting a cross-validation algorithm to search the adjustable parameter and the penalty parameter, if the characteristic model is trained through the support vector machine model.

11. An electronic apparatus, comprising:
at least one processor; and
a memory communicatively connected to the at least one processor; wherein,
the memory stores instructions which could be processed by the at least one processor, the instructions are executed by the at least one processor so that the at least one processor is capable of:
dimensionally reducing a video to be identified, obtaining an input characteristic parameter of the video to be identified;
invoking a characteristic model trained in advanced according to the input characteristic parameter, determining whether the video to be identified is an animated video; and
adjusting a coding parameter and a bit rate of the video to be identified, if it is determined that the video to be identified is the animated video.

12. The electronic apparatus according to claim 11, wherein, the dimensionally reducing the video to be identified comprises:
obtaining each video frame of the video to be identified;
transforming a non-RGB color space of the video frame into a RGB color space;
counting a R grayscale histogram, a G grayscale histogram, a B grayscale histogram of the RGB color space;
respectively calculating a standard deviation of the R grayscale histogram, a standard deviation of the G grayscale histogram, and a standard deviation of the B grayscale histogram; and
respectively implementing an edge detection processing for the video frame at a R color channel, a G color channel, and a B color channel, obtaining a number of contours of the R color channel, a number of contours of the G color channel and a number of contours of the B color channel

13. The electronic apparatus according to claim 11, wherein, the characteristic model trained in advanced comprises:
dimensionally reducing a video sample to obtain an input characteristic parameter of the video sample, wherein the input characteristic parameter of the video sample includes the standard deviation of R grayscale histogram, the standard deviation of G grayscale histogram, the standard deviation of B grayscale histogram, the number of contours of R color channel, the number of contours of G color channel and the number of contours of B color channel; and
training the characteristic model through a support vector machine model according to the input characteristic parameter of the video sample.

14. The electronic apparatus according to claim 13, wherein, the training the characteristic model through the support vector machine further comprises:
the characteristic model is expressed as a formula following:
$$f ( x ) = sgn \{ {\sum }_{i = 1}^{l} {α}_{i}^{*} {y}_{i} K ( x , {x}_{i} ) + {b}^{*} \} ;$$
wherein x represents an input characteristic parameter of the video to be identified, xᵢ represents an input characteristic parameter of the video sample, f(x) represents a classification of the video to be identified, an output value of f(x) is 1 or −1 according to a characteristic of a symbol function sgn( )1 or −1 respectively represents an animated video and a non-animated video; K is a kernel function calculated according to a predetermined adjustable parameter and the input characteristic parameter of the video sample; a*ᵢ and b* respectively represents a relative parameter of the characteristic model, a*ᵢ and b* are calculated according to a predetermined penalty parameter and the input characteristic parameter of the video sample.

15. The electronic apparatus according to claim 14, wherein, the processor is further capable of:
selecting a cross-validation algorithm to search the adjustable parameter and the penalty parameter, if the characteristic model is trained through the support vector machine model.
